(19) United States
(12) Patent Application Publication
(10) Pub. No.: US 2004/0231750 A1
(43) Pub. Date: Nov. 25, 2004

(54) Laminate sheet seaming system

(76) Inventor: Arnold A. VanCleave, Coeur d'Alene, ID (US)

Correspondence Address: Michael S. Neustel, Suite No. 4, 2534 South University Drive, Fargo, ND, 58103, US

(21) Appl. No.: 10/441,660

(22) Filed: May 19, 2003

(51) Int. Cl. B25H 1/00

(52) U.S. Cl. 144/286.5

(57) ABSTRACT

A laminate sheet seaming system for efficiently seaming two laminate sheets. The laminate sheet seaming system includes a base with a cutting channel, and a first locking member and a second locking member mechanically attached to the base for securing a first laminate sheet and a second laminate sheet respectively to the base. The user utilizes a router to create a slot between the two laminate sheets thereby creating an accurate seam between the two laminate sheets.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to laminate sheet-cutting tools and more specifically it relates to a laminate sheet seaming system for efficiently seaming two laminate sheets.

2. Description of the Related Art

Laminate sheeting has been in use for use in applications such as but not limited to countertops, edging and backsplashes. In larger applications a laminate installer must secure more than one laminate sheet adjacent one another.

It is time consuming for the laminate installer to accurately cut the abutting edges of the laminate sheets so they form an acceptable seam together. Often times the seam formed between the two laminate sheets is readily apparent to the average observer thereby reducing the aesthetics of the laminate sheeting. In addition, the laminate installer may damage the laminate sheeting attempting to create an accurate seam.

Examples of patented devices which may be related to the present invention include U.S. Pat. No. 5,375,636 to Bosten et al.; U.S. Pat. No. 5,195,730 to Taylor; U.S. Pat. No. 5,421,566 to Morgan; U.S. Pat. No. 5,149,072 to Sartorio et al.; U.S. Pat. No. 4,892,020 to Kozyrski et al:; U.S. Pat. No. 4,252,304 to Pettican; U.S. Patent Application 2003/0034601 filed by Kloepfer et al.; U.S. Pat. No. 6,070,626 to Tully; U.S. Pat. No. 5,816,300 to Rogers; U.S. Pat. No. 5,486,324 to Klein, Jr.; and U.S. Pat. No. 5,595,427 to Peters et al.

While these devices may be suitable for the particular purpose to which they address, they are not as suitable for efficiently seaming two laminate sheets. Conventional methods and devices for creating laminate sheeting seams do not provide a professional end product and are time consuming to utilize.

In these respects, the laminate sheet seaming system according to the present invention substantially departs from the conventional concepts and designs of the prior art, and in so doing provides an apparatus primarily developed for the purpose of efficiently seaming two laminate sheets.

### BRIEF SUMMARY OF THE INVENTION

In view of the foregoing disadvantages inherent in the known types of laminate sheeting tools now present in the prior art, the present invention provides a new laminate sheet seaming system construction wherein the same can be utilized for efficiently seaming two laminate sheets.

The general purpose of the present invention, which will be described subsequently in greater detail, is to provide a new laminate sheet seaming system that has many of the advantages of the laminate sheeting tools mentioned heretofore and many novel features that result in a new laminate sheet seaming system which is not anticipated, rendered obvious, suggested, or even implied by any of the prior art laminate sheeting tools, either alone or in any combination thereof.

To attain this, the present invention generally comprises a base with a cutting channel, and a first locking member and a second locking member mechanically attached to the base for securing a first laminate sheet and a second laminate sheet respectively to the base. The user utilizes a router to create a slot between the two laminate sheets thereby creating an accurate seam between the two laminate sheets.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a laminate sheet seaming system that will overcome the shortcomings of the prior art devices.

A second object is to provide a laminate sheet seaming system for efficiently seaming two laminate sheets.

Another object is to provide a laminate sheet seaming system that creates two opposing straight edges to create an aesthetically pleasing seam between two laminate sheets.

An additional object is to provide a laminate sheet seaming system that may be utilized with various types of laminate sheet materials.

A further object is to provide a laminate sheet seaming system that is small, compact and lightweight.

Another object is to provide a laminate sheet seaming system that can accommodate various sizes of routers and router blades.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with a first sheet and a second sheet positioned under the first locking member and the second locking member respectively.

FIG. 3 is an upper perspective view of the present invention with a first sheet and a second sheet locked under the first locking member and the second locking member respectively.

FIG. 4 is an end view of the present invention.

FIG. 5 is a top view of the present invention.

FIG. 6 is a side view of the present invention.

FIG. 7a is a top view of the present invention with a first sheet and a second sheet positioned under the first locking member and the second locking member respectively.

FIG. 7b is a top view of the present invention with the two sheets with a router cutting a slot between thereof.

FIG. 7c is a top view of the present invention with the two sheets having a slot cut between thereof thereby creating two opposing straight edges.

### DETAILED DESCRIPTION OF THE INVENTION

A. Overview

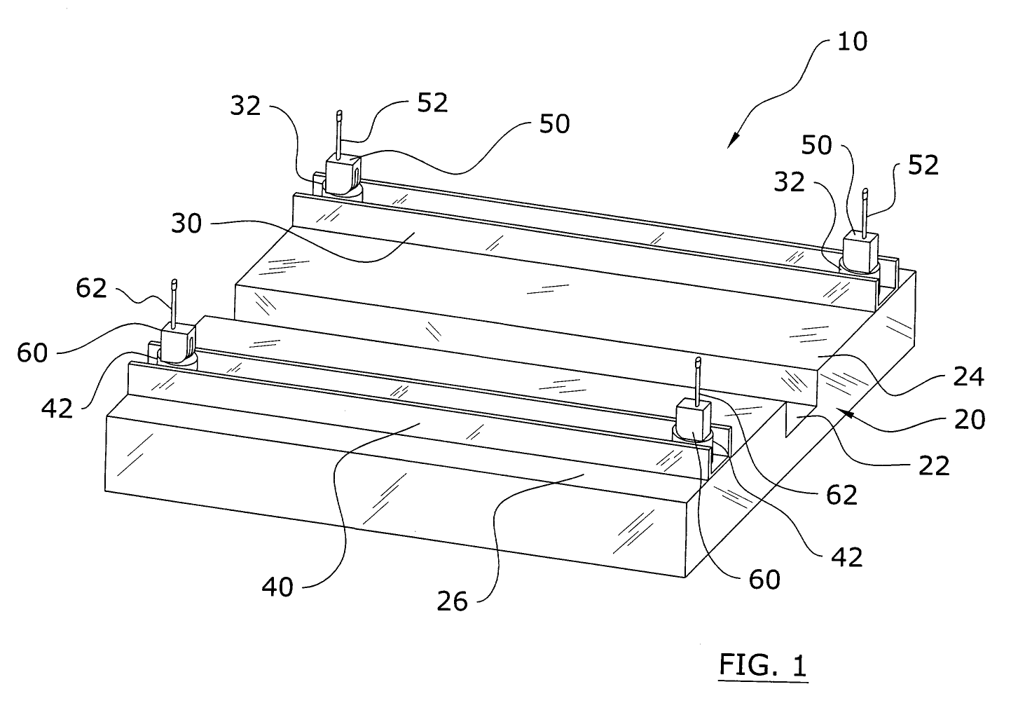

Turning now descriptively to the drawings, in which similar reference characters denote similar elements throughout the several views, FIGS. 1 through 7c illustrate a laminate sheet seaming system 10, which comprises a base 20 with a cutting channel 22, and a first locking member 30 and a second locking member 40 mechanically attached to the base 20 for securing a first laminate sheet 12 and a second laminate sheet 14 respectively to the base 20. The user utilizes a router to create a slot between the two laminate sheets thereby creating an accurate seam between the two laminate sheets.

B. Base

As shown in FIGS. 1 through 7c of the drawings, the base 20 has a cutting channel 22 defining a first surface 24 and a second surface 26. The base 20 may be comprised of various types of materials and structures.

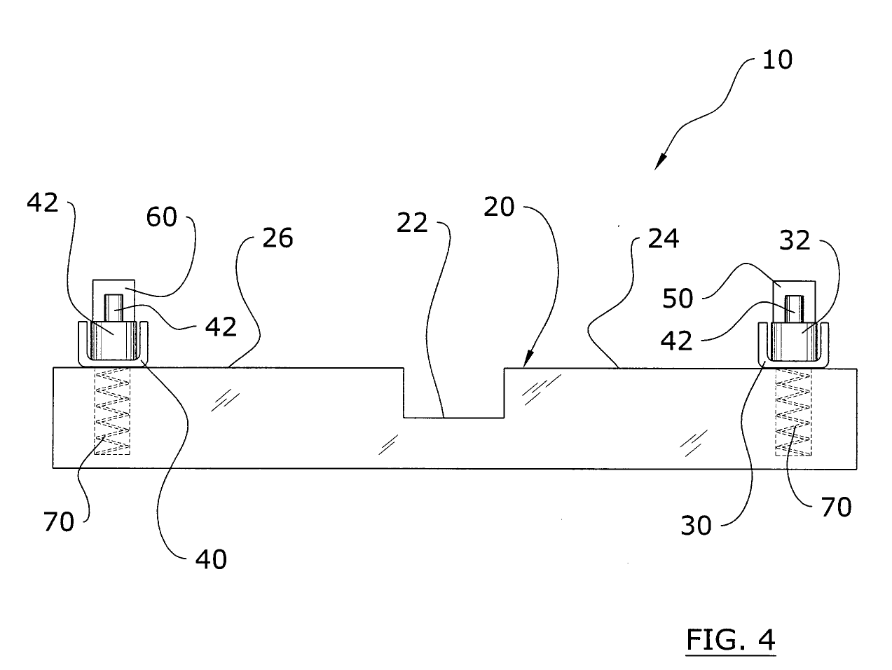

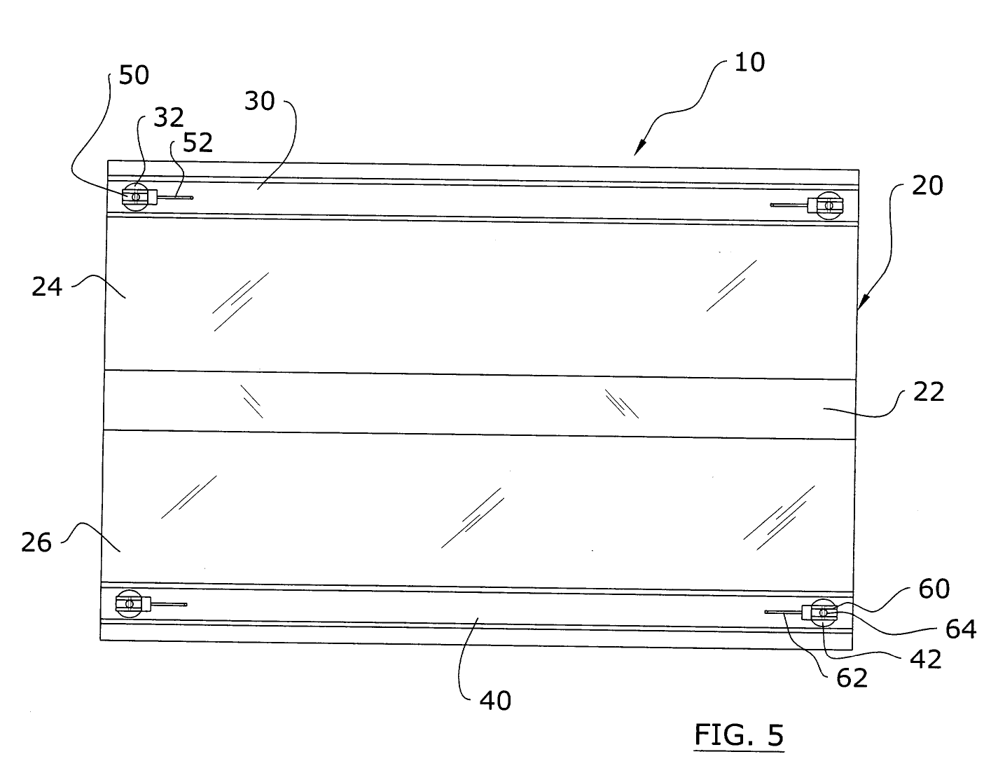

The cutting channel 22 is capable of receiving a conventional router blade of a router unit 16. The cutting channel 22 is preferably centrally positioned between the first locking member 30 and the second locking member 40 as best illustrated in FIG. 5 of the drawings. As best shown in FIG. 5 of the drawings, the cutting channel 22 is a straight structure. In addition, the cutting channel 22 is preferably comprised of a rectangular cross section as best illustrated in FIG. 4 of the drawings to accommodate various sizes of router blades.

The first surface 24 and the second surface 26 have relatively broad surface areas to adequately support a first laminate sheet 12 and a second laminate sheet 14 as shown in FIG. 5 of the drawings. The first surface 24 and the second surface 26 are preferably parallel and aligned to one another.

C. Locking Members

The first locking member 30 is attached to the base 20 above the first surface 24 for selective receiving and securing a first laminate sheet 12 between thereof. The first locking member 30 is comprised of an elongate structure and preferably has a U-shaped cross sectional shape (though other cross sectional shapes may be utilized).

A plurality of first cam levers 50 are attached to the base 20 and mechanically engaging the first locking member 30. More particularly, the plurality of first cam levers 50 are attached to first posts attached within the base 20 that extend through an aperture within the first locking member 30.

The first cam levers 50 preferably include corresponding first handles 52. The first cam levers 50 are preferably positioned at opposing ends of the first locking member 30 as best illustrated in FIG. 5 of the drawings.

A first spacer 32 is positioned between each of the first cam levers 50 and the first locking member 30 as shown in FIG. 1 of the drawings. The first spacer 32 preferably surrounds the first post directly above and adjacent to the first locking member 30. The first spacer 32 is preferably comprised of a resilient material to reduce damage to the first laminate sheet 12 when compressed between the first locking member 30 and the first surface 24 of the base 20. The first cam levers 50 have a curved cam edge that apply a downward force to the first spacer 32 when pivoted about the first post effectively forcing the first locking member 30 downwardly upon the first laminate sheet 12.

The second locking member 40 is attached to the base 20 above the second surface 26 for selective receiving and securing a second laminate sheet 14 between thereof. The second locking member 40 is comprised of an elongate structure and preferably has a U-shaped cross sectional shape (though other cross sectional shapes may be utilized).

A plurality of second cam levers 60 are attached to the base 20 and mechanically engaging the second locking member 40. More particularly, the plurality of second cam levers 60 are attached to second posts 44 attached within the base 20 that extend through an aperture within the second locking member 40.

The second cam levers 60 preferably include corresponding second handles 62. The second cam levers 60 are preferably positioned at opposing ends of the second locking member 40 as best illustrated in FIG. 5 of the drawings.

A second spacer 42 is positioned between each of the second cam levers 60 and the second locking member 40 as shown in FIG. 1 of the drawings. The second spacer 42 preferably surrounds the second post directly above and adjacent to the second locking member 40. The second spacer 42 is preferably comprised of a resilient material to reduce damage to the second laminate sheet 14 when compressed between the second locking member 40 and the second surface 26 of the base 20. The second cam levers 60 have a curved cam edge that apply a downward force to the second spacer 42 when pivoted about the second post effectively forcing the second locking member 40 downwardly upon the second laminate sheet 14.

As shown in FIG. 5 of the drawings, the first locking member 30 and the second locking member 40 are parallel to one another. The first locking member 30 and the second locking member 40 are also parallel to the cutting channel 22 as further shown in FIG. 5 of the drawings.

D. Springs

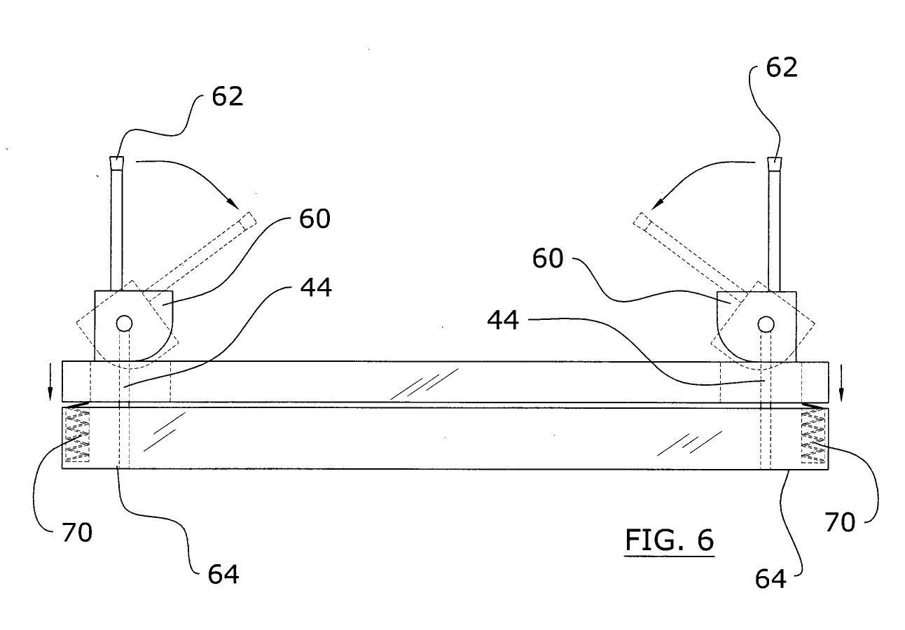

As shown in FIGS. 4 and 6 of the drawings, a plurality of springs 70 are within the base 20 that apply an upward force to the first locking member 30 and the second locking member 40. The springs 70 may be positioned within cavities within the base 20 and engage the lower surface of the locking members 30, 40. Various other biasing mechanisms may be utilized to apply a biasing force to the locking members 30, 40.

E. Operation

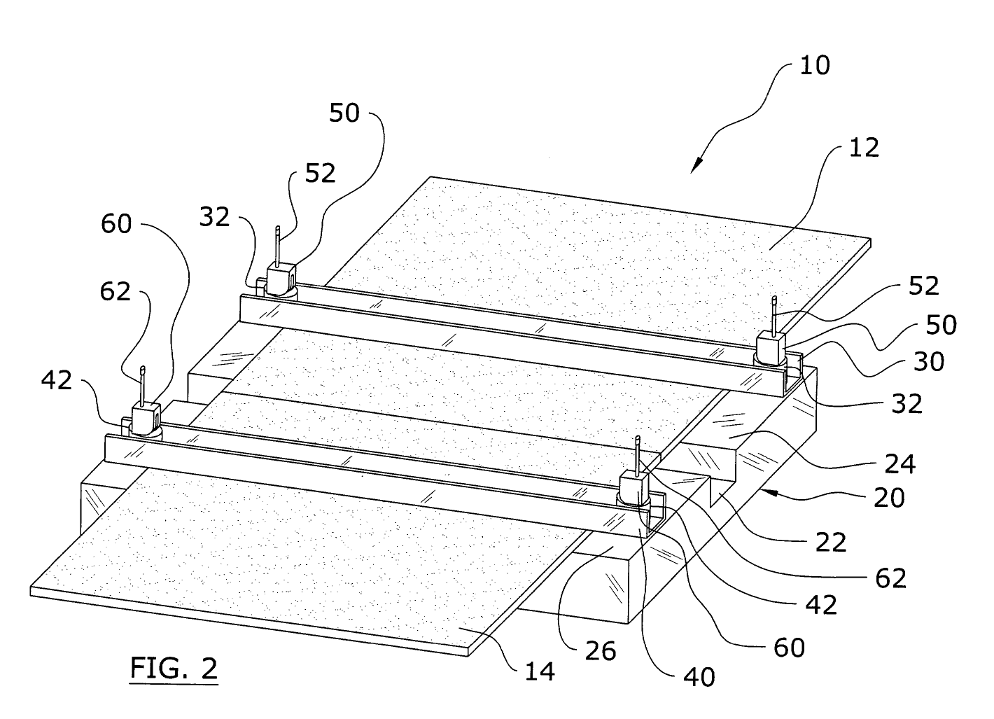

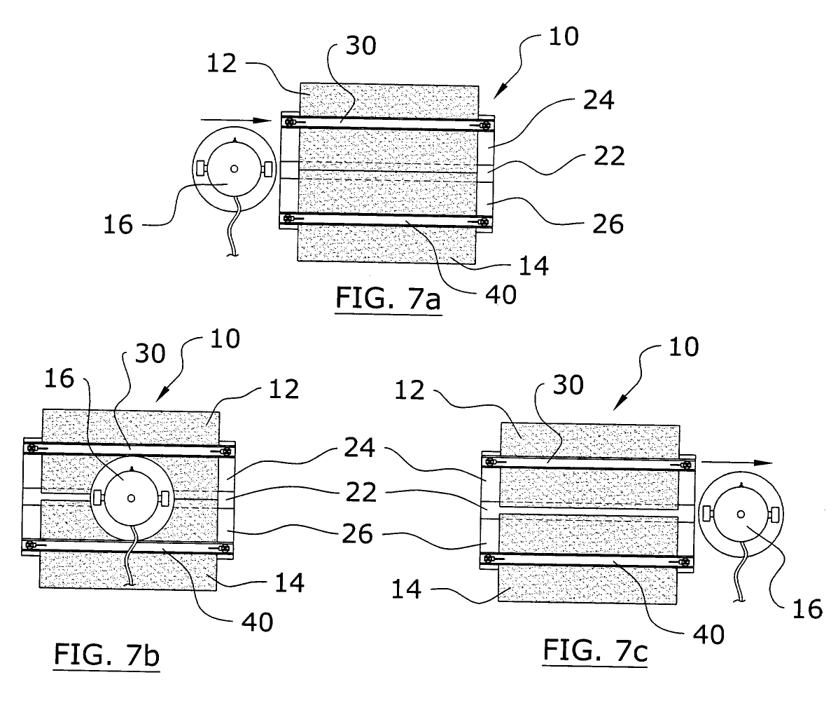

In operation, the user positions the first laminate sheet 12 between the first surface 24 and the first locking member 30. The user then positions the second laminate sheet 14 between the second surface 26 and the second locking member 40 with the edge of the second laminate sheet 14 adjacent the edge of the first laminate sheet 12 above the cutting channel 22 as shown in FIGS. 2 and 7a of the drawings.

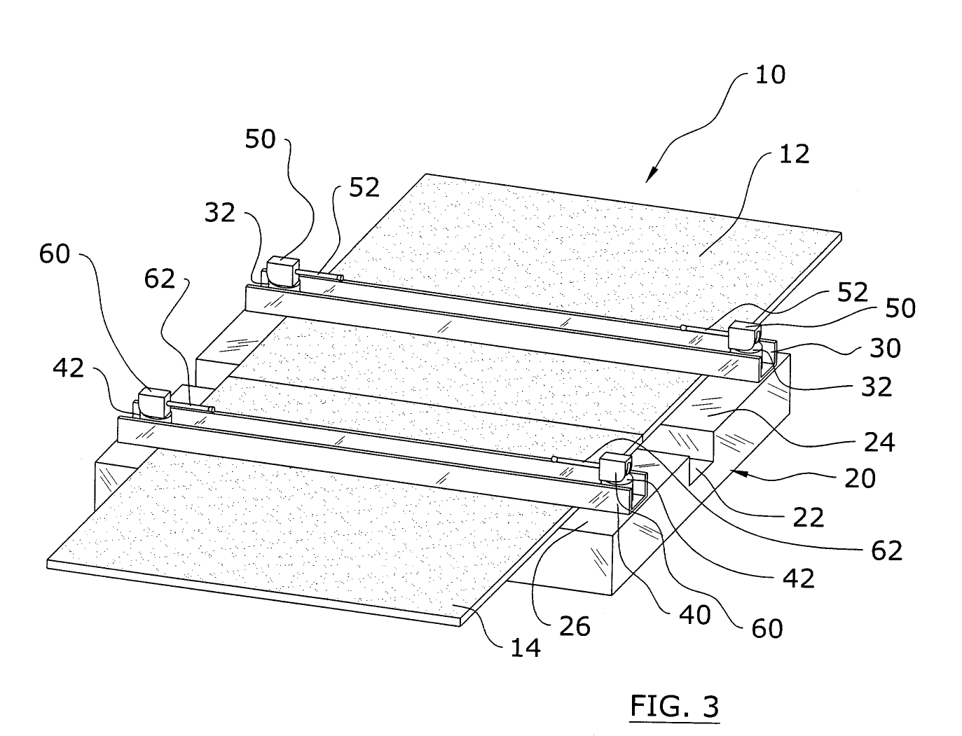

The user then secures the locking members 30, 40 upon the laminate sheets 12, 14 by manipulating the cam levers 50, 60 as shown in FIG. 3 of the drawings. The lower surface of the locking members 30, 40 engage the laminate sheets 12, 14 thereby retaining the laminate sheets 12, 14 in a secure position with the opposing edges adjacent one another.

The user then utilizes a conventional router unit 16 and cuts a slot between the laminate sheets 12, 14. The user must ensure that opposing portions of each of the laminate sheets 12, 14 must be removed by the blade of the router unit 16 as shown in FIG. 7b of the drawings. The user continues cutting through the laminate sheets 12, 14 until the slot fully extends through the laminate sheets 12, 14 as shown in FIG. 7c of the drawings.

The user then releases the cam levers 50, 60 where after the springs 70 elevate the locking members 30, 40 from the laminate sheets 12, 14. The user then removes the laminate sheets 12, 14 from the present invention and then may secure them to a surface with the edges formed by the cut slot creating a uniform and aesthetically pleasing seam.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A laminate sheet seaming system, comprising:
a base having a cutting channel defining a first surface and a second surface, wherein said cutting channel is capable of receiving a router blade;
a first locking member attached to said base above said first surface for selective receiving and securing a first laminate sheet between thereof; and
a second locking member attached to said base above said second surface for selective receiving and securing a second laminate sheet between thereof.

2. The laminate sheet seaming system of claim 1, wherein said first surface and said second surface are parallel to one another.

3. The laminate sheet seaming system of claim 2, wherein said first surface and said second surface are aligned with one another.

4. The laminate sheet seaming system of claim 1, wherein said cutting channel is a straight structure.

5. The laminate sheet seaming system of claim 1, wherein said cutting channel is centrally positioned between said first locking member and said second locking member.

6. The laminate sheet seaming system of claim 1, wherein said first locking member and said second locking member are each comprised of an elongate structure.

7. The laminate sheet seaming system of claim 6, wherein said first locking member and said second locking member are parallel to one another.

8. The laminate sheet seaming system of claim 7, wherein said first locking member and said second locking member are parallel to said cutting channel.

9. The laminate sheet seaming system of claim 1, including a plurality of springs within said base that apply an upward force to said first locking member and said second locking member.

10. The laminate sheet seaming system of claim 1, wherein said first locking member and said second locking member each have a U-shaped cross section.

11. A laminate sheet seaming system, comprising:
a base having a cutting channel defining a first surface and a second surface, wherein said cutting channel is capable of receiving a router blade;
a first locking member attached to said base above said first surface for selective receiving and securing a first laminate sheet between thereof;
a plurality of first cam levers attached to said base and mechanically engaging said first locking member;
a second locking member attached to said base above said second surface for selective receiving and securing a second laminate sheet between thereof; and
a plurality of second cam levers attached to said base and mechanically engaging said second locking member.

12. The laminate sheet seaming system of claim 11, wherein said first cam levers each include first handles and wherein said second cam levers each includes second handles.

13. The laminate sheet seaming system of claim 11, including a first spacer positioned between each of said first cam levers and said first locking member, and a second spacer positioned between each of said second cam levers and said second locking member.

14. The laminate sheet seaming system of claim 13, wherein said first spacer and said second spacer are comprised of a resilient material.

15. The laminate sheet seaming system of claim 11, wherein said cutting channel is centrally positioned between said first locking member and said second locking member.

16. The laminate sheet seaming system of claim 11, wherein said first locking member and said second locking member are each comprised of an elongate structure.

17. The laminate sheet seaming system of claim 16, wherein said first locking member and said second locking member are parallel to one another.

18. The laminate sheet seaming system of claim 17, wherein said first locking member and said second locking member are parallel to said cutting channel.

19. The laminate sheet seaming system of claim 11, including a plurality of springs within said base that apply an upward force to said first locking member and said second locking member.

20. The laminate sheet seaming system of claim 11, wherein said first locking member and said second locking member each have a U-shaped cross section.
